(19) United States
(12) Patent Application Publication
(10) Pub. No.: US 2022/0021042 A1
(43) Pub. Date: Jan. 20, 2022

(54) PLANT FOR THE DISPOSAL OF LITHIUM BATTERIES AND RECOVERY OF LITHIUM

(71) Applicant: ESPLODENTI SABINO S.R.L., Lanciano (CH) (IT)

(72) Inventors: Giustiniano TIBERIO, Lanciano (CH) (IT); Domenico D'OTTAVIO, Lanciano (CH) (IT); Salvatore COSTA, Lanciano (CH) (IT)

(21) Appl. No.: 17/262,554

(22) PCT Filed: Jul. 4, 2019
(86) PCT No.: PCT/IB2019/055716

§ 371 Date: Jan. 22, 2021

(30) Foreign Application Priority Data
Jul. 23, 2018 (IT) 102018000007426

(51) Int. Cl. H01M 10/54; C22B 26/12; C22B 7/00; C22B 1/00

(52) U.S. Cl. CPC H01M 10/54; C22B 1/005; C22B 7/006; C22B 26/12

(57) ABSTRACT

Plant for disposing and recovering lithium batteries, including: storage; supply; crushing, submerged in liquid solution and in overpressure of inert gas, for destroying the batteries through cutting discs and milling cutters; torch for burning the gaseous residue and possible organic solvents; centrifugation and screening of the scrap; evaporation, for removing the volatile solvents and concentrating the lithium in solution; recovery of the heavy metals, with chemical/physical reactor which, by way of a filter press, distributes the products between a liquids tank and a solids tank; recovery of lithium wherein the lithium is recovered through the crystallisation of lithium carbonate by adding sodium carbonate and heating, contained in a tank and heating the solution in a special heated tank, in a chemical/physical reactor.

### FIELD OF THE ART

The present invention regards the field of plants for disposing waste and recycling waste materials. More in detail, the plant in question regards the destruction, disposal and recovery of lithium and “black mass” from which other metals such as Cobalt, Copper, Aluminium, Nickel, Manganese, etc. contained in lithium batteries of any type available in the market is to be recovered, in a safe manner.

### PRIOR ART

As per current state of the art there are no effective plants as concerns the end of life handling of the lithium batteries and above all for recovering the lithium with a high degree of purity that allows re-introduction thereof into the market, for technical or pharmaceutical purposes.

This is due to the fact that the presence of lithium (Li) in metallic state creates considerable safety problems due to the high reactivity of the material with water which determines the release of hydrogen and thus the possibility of creating an explosive atmosphere in presence of oxygen.

Despite these criticalities, the use of Lithium batteries has been considerably growing in recent years, contrary to the disposal technologies which are yet to devise a plant capable of recovering the materials in a safe manner, irrespective of the type of battery.

The need to create a plant universally valid for all lithium batteries arises from the fact that they are often scarcely recognisable to the naked eye and, due to the reasons above, disassembling them outside the plant entails considerable risks of explosion and fire.

In any case, the operating principle of all batteries is always similar and it is based on the reduction reaction of Lithium (anode or negative electrode) combined with the oxidation of another component (cathode or positive electrode) specific for each technology. The presence of an electrolyte, also specific for the technology of the cell, is crucial towards guaranteeing electrical contact. Also present are components such as the separator, the grids, the conductors, the venting devices, the collectors, the non-spill designs, the casings, the container, the labels, etc.

A differently operating mechanism in case of Lithium ion accumulators, in which a guest matrix allows the insertion and removal of Li+ ions in a reversible fashion and without structural changes to the guest.

Unfortunately, given that the disposal of batteries is a field of application that is relatively recent and still marginal up to date in terms absolute volumes of waste per year (currently close to 450 tons/year in Italy) to be treated, there are no technologies universally recognised as the best for this field.

However, there are situations where the treatment is carried out thermally in rotary furnaces. Furthermore, this high environmental and economic impact strategy entails major safety problems regarding the presence of metallic lithium not destroyed in the scrap material (called Black Mass) which makes transportation for subsequent processing hazardous. This approach represents an unsustainable process.

These challenges are clearly observable from reports on serious accidents in battery treatment plants which, due to the fact that Lithium cannot be extinguished using normal water-based fire extinguishing systems, entail the serious problem related to managing this type of problem.

Some grinding and crushing tests which clearly show the dangerousness of mechanical breaking of Lithium batteries of any type are also known.

The project has the object of overcoming the aforementioned criticalities and recovering the produced lithium to obtain a material that can be sold in the market.

### DESCRIPTION OF THE INVENTION

According to the present invention, a plant for the disposal of Lithium batteries and recovery of lithium which effectively solves the aforementioned problems is provided.

The present invention has the main objective of recovering the produced Lithium and obtaining a material that can be sold in the market with high purity standards which allow sales thereof in the technical or pharmaceutical industry. The process is advantageously designed for production according to the British/United States standards, whose specifications are as follows:
BP (British Pharmaceutical)
   Li₂CO₃—73.9—554-13-2
   Content: 98.5% to 100.5%.
   Appearance: white or almost white powder;
   Solubility: slightly soluble in water, practically insoluble in 96% ethanol.
USP (United States Pharmaceutical)
   Li₂CO₃—73.89
   Carbonic acid, dilithium salt.
   Dilithium carbonate—[554-13-2].
   Lithium carbonate contains not less than 99.0% of Li₂CO₃, calculated on the dried base.

Advantageously, the present plant can be universally used for all types of Lithium batteries available in the market, thus without having to be subjected to a previous sorting step which, besides increasing the dangerousness of the operations, could also be counter-productive and easily lead to mistakes relating to differentiation between the various batteries.

The process is based on crushing, under safe conditions, the batteries to prevent explosions during the operations for treating or obtaining materials with risk of explosion such as exiting products (generally called Black Mass).

In order to meet such goals, the material is advantageously crushed in aqueous solution or in inert atmosphere which offers the following advantages:
1) upon contact with water, metallic lithium undergoes complete inertisation definitely losing the explosivity characteristic;
2) crushing in an oxygen deficient environment (counterpart for the combustion/explosion process);
3) absence of trigger sources deriving from rubbing or overheating;
4) possibility of separating lithium for the subsequent recovery operations (in form of carbonate);
5) absorption of inorganic substances coming from the electrolyte available for the subsequent recovery operations.

However, this approach reveals the following aspects to be monitored closely:
a) management of the hydrogen produced by the reaction of the metallic Lithium with water;
b) management of acid fumes/solvents coming from the internal electrolyte;
c) verifying the composition of the water.

As regards the risks to be monitored during the process, below are the various risk factors and the relative solutions provided by the system subject of the present patent:
risk of fire/explosion: eliminated by treating the batteries in a submerged fashion and in that the crushing area operates under slight pressure (preferably 100 mBars). Advantageously, in an embodiment of the present invention, the system is provided with pressure sensors connected to actuators which control a tank for inert gas, such as for example nitrogen, which is insufflated into the crushing chamber when the internal pressure drops below a pre-established safety threshold, preferably equal to 30 mBars. Still with the aim of preventing fire and explosions that could also propagate to other areas such as the material storage and loading areas which must thus be suitably partitioned into two or more sectors:
characterisation risk regarding exiting products, which is advantageously nullified by the presence (preferable and provided for in the preferred embodiment) of a special analysis laboratory, suitable to verify the composition of the recovered materials to verify whether they meet the aforementioned purity standards;
risk of uncontrolled emissions due to fumes emitted by the burning torch which disposes the waste hydrogen deriving from the crushing and possible organic solvents present in the batteries. Said torch is advantageously integrated in the plant subject of the present invention. In particular, the risk relates to the emission of inorganic acids (HCl, SO₃, etc.), inorganic gases (SO₂, NH₃) and volatile organic solvents which occurs in the destruction of the batteries. The reduction of this risk is due to the presence of a purifier downstream of the crushing area but in order to verify the correct operation thereof and fully eliminate this environmental risk, an extraction system aimed at continuously monitoring the presence of said inorganic acids and gases and solvents, installed and consisting of at least one FT-IR analyser and one COT analyser, is advantageously provided for. Should the flow of hydrogen (even following possible preliminary selection of the batteries) be sufficiently pure, the torch could be replaced by a fuel cell for recovering electrical energy from the system and make the system even more sustainable from an environmental and economic viewpoint.

From a storage area, suitably configured to reduce the risk of uncontrolled deterioration and excessive storage of the used batteries, a common supply plant provides such batteries to the crushing area.

This, advantageously, operates in a submerged fashion and under slight overpressure in an inert environment. Here, a plurality of rotating shafts actuate cutting discs provided with hooks and milling cutters that destroy the batteries. All this occurs in a liquid solution at and/or in an inert gas atmosphere (nitrogen) controlled by special sensors (Temperature, pressure, pH, rH % O₂) which control the process by actuating the valves, as mentioned above, or shutting off the supply flow of the batteries to eliminate the possibility of inflow of oxygen or creation of hazardous conditions.

Advantageously present downstream of the milling cutters is a grid which allows to control the grain size of the residues. The largest residues can be possibly returned upstream so as to undergo the crushing process just described above once again.

The solid residues that traverse the grid are conveyed, by an auger-like or scraping chain discharge system, to a scrap screening area in which they are divided according to the type of material in different containers to be sent to possible subsequent recovery operations. Such scrap material is usually referred to as “Black Mass” and following the centrifugation and separation operation by means of static magnetic systems of by induction they are sent to the subsequent noble metals recovery operations.

Advantageously and suitably positioned above the submerged portion of the crushing area is a purifier suitable to treat the effluents emitted by the crushing process to absorb the gases, the inorganic acids and possible vapours of solvents thereof, thus reducing the risk of emissions. The entire produced hydrogen is sent to a combustion device consisting of a torch, or if qualitatively appropriate, a fuel cell for the production of electrical energy starting from said hydrogen or from atmospheric or synthesis oxygen.

Advantageously, in an embodiment of the present invention, a monitoring cabin will analyse the composition of the gas flowing into the torch verify it for the absence of pollutant components.

Still provided for downstream of the crushing area is a filter followed by a recycling pump for supplying the absorption column and transferring part of the reaction solution to the subsequent operations. The surplus liquid part is conveyed towards a filter for eliminating suspended solids. These solids are chemically compatible with the characteristics of the “Black Mass” and they can be exploited to recover materials of commercial value.

The water coming from the grinding will be subjected to chemical/physical treatment for the recovery of heavy metals. The crushing process water, filtered and then arranged in a chemical/physical reactor provided with stirrer and by adding chemical agents for the formation of Insoluble salts (such as Na₂S, NaOH, NH3, etc.), allows, by means of a filter press, to sort the obtained products, thus removing heavy metals from the solution containing soluble lithium.

The supernatant separated from the sludge is then sent to the evaporation area which receives the water containing soluble organic solvents and diluted lithium in solution. By evaporating under vacuum, power-supplied electrically or by steam, the inflowing product is separated into “evaporated” and “concentrated” in relative storage tanks. The vacuum can be obtained by means of a recycling pump with ejector or by means of a specific atex vacuum pump.

Following concentration, the liquid resulting from the evaporation process, and preferably still hot, is transferred to a subsequent chemical/physical reactor with stirrer and heated by means of electrical resistors or steam heating jacket. Concentrated sodium carbonate (Na₂CO₃) is then added to the solution and it is heated to a temperature exceeding 60° C., obtaining the following reaction:

2 L(OH)+NaCO3+heat→Li2CO3(s)+2 Na(OH)

The separation of lithium carbonate occurs physically by heat by means of a filter press. The lithium recovery area waste products are sorted between a liquids tank and lithium carbonate dryer.

In a preferred embodiment of the present invention the material present in the lithium dryer is analysed by a special laboratory which verifies the purity parameters for re-introducing the lithium into the market.

All areas for the storage of waste coming from the aforementioned processing are suitably configured to avoid any possible spilling of the content and they are positioned in sheltered areas.

The advantages provided by the present invention will be clear in light of the description outlined up to now. Furthermore, they will be more apparent due to the attached figures and relative detailed description.

### DESCRIPTION OF THE FIGURES

The invention will be described hereinafter in at least one preferred embodiment, provided by way of non-limiting example, with reference to the attached figures, wherein:

FIG. 1 shows a general diagram of the plant subject of the present invention identified in which are macro areas, i.e.: the storage area 10, the supply 20, the crushing area 30, the torch 40 (or alternatively the cell fuel), the evaporation area 50, the Lithium recovery area 60, the heavy metals recovery area 55, the scrap material screening and centrifugation area 70 the monitoring cabin 90.

FIG. 2 illustrates more in detail the submerged crushing area 30 shown in which are four shafts 31 connected to cutting discs 32. Arranged downstream of the machine, or after grinding, is a grid 33 with pre-stablished mesh-size so as to allow the passage, downstream, of the ground pieces that do not exceed a given size.

FIG. 3 shows an operating diagram of the purifier 35 suitable to absorb inorganic acids and gases and vapours of solvents.

FIG. 4 shows a closer view of the torch 40 for the combustion of the hydrogen resulting from the crushing of the batteries.

FIG. 5 shows the evaporation area 50 in which an evaporator 51 provided with a system for the recirculation of vapour 51′ connected to a boiler (not represented) or with electric heating and suitable to sort the obtained products between a tank for the concentrated product 52, which will be conveyed to the treatment and recovery area 60, and a tank for the evaporated product 54, by means of a common atex vacuum pump 53.

FIG. 6 shows a Lithium recovery area 60 converging in which, in the chemical/physical reactor with stirrer and heating 61, are the Na₂CO₃ solution from a dedicated tank 65 and the waste liquid of the evaporation process (evaporation area 50) contained in a heated tank 64. From here, the waste products are sorted between a liquids tank 63 and a Lithium dryer 62 in turn connected to the analysis laboratory 100 and to the relative weighing and packaging installation 110 for re-introduction into the market.

FIG. 7 illustrates the area for screening the scrap material 70 coming from the auger 36 for discharging the crushing area 30. Here, a waste separation plant 71 sorts the received material into a plurality of containers 72-72′-72″ distinguishing them according to the type of waste.

FIG. 8 shows, more in detail, the heavy metals recovery area 55 in which a chemical/physical reactor with stirrer 56, by means of a filter press 57, sorts the obtained products between a waste liquids tank 58 and a solids tank 59 containing the heavy metals meant for recovery.

### DETAILED DESCRIPTION OF THE INVENTION

Now, the present invention will be illustrated purely by way of non-limiting or non-binding example, with reference to the figures illustrating some embodiments regarding the present inventive concept.

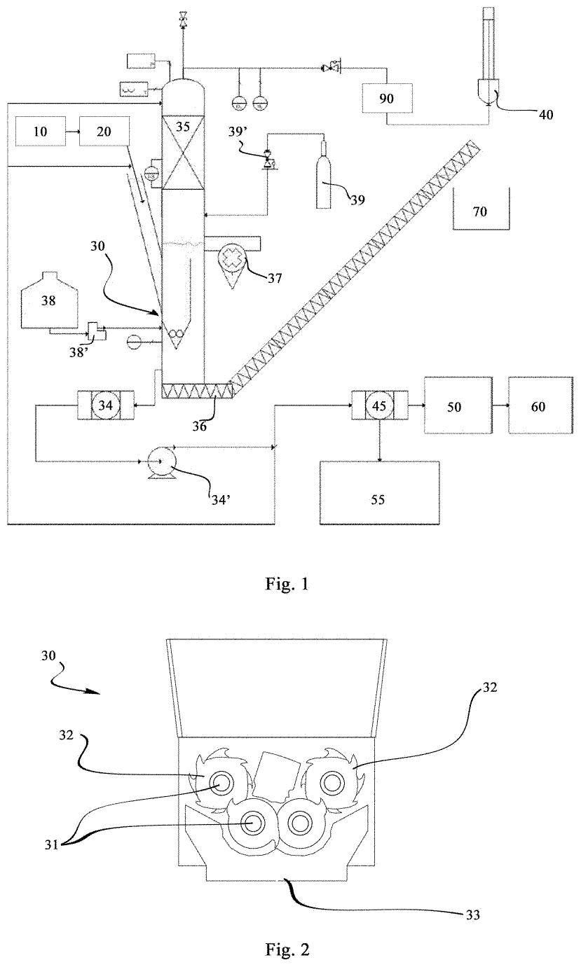

Shown with reference to FIG. 1 is the general diagram of the plant for the disposal of batteries and recovery of Lithium subject of the present invention.

The storage area 10, upstream of the plant, must be protected against atmospheric agents and made waterproof. The storage area 10 will be divided into at least two compartments into which the waste will be alternatingly discharged for storage according to the “First In-First Out” criterion. The area can be provided with fire safety measures (partitioning and suffocation systems) in order to reduce fire risks.

The supply system 20, in which a forklift will preferably discharge the batteries accumulated in a loading hopper, starts from the storage area 10. The batteries will then be transferred into the crushing area 30 using a common conveyor belt.

The crushing area 30 is pivoted around a crusher better represented in FIG. 2. The physical opening of the batteries occurs here and, in order to avoid the risk of explosion and thus triggering fire, all opening activities are carried out in a submerged fashion and in controlled atmosphere. The liquid solution is stored in a special tank 38 and supplied to area 30 by means of a common dosing pump 38′. The plant is also provided with a foam discharge system 37. In this case, the crusher consists of four shafts 31 with cutting discs 32 (discs with sharp edges provided with hooks). Each hook that the cutting discs 32 are provided with has the purpose of hooking the product and conveying it towards the milling cutters also mounted on the counter-rotating drive shafts 31 which cut the material decisively. The system is provided with an alternating current asynchronous electric motor arranged outside the submerged crushing area. Present downstream of the milling cutters is a grid 33 with mesh-size comprised between 10 mm and 35 mm which allows to control the grain size of the residues. The largest residues can be possibly returned upstream so as to undergo the crushing process just described above once again.

As previously illustrated, due to safety reasons the crushing area 30 operates under slight overpressure so as to prevent the inflow of oxygen. Thanks to the presence of hydrostatic head, the internal pressure of the cutting area can be brought to a preferred value of 120 mBars. Suitable pressure sensors, connected to insufflation valves 39′ and connected to a nitrogen tank 39, will keep the pressure value within the pre-established threshold values. Should the desired pressure be exceeded, the surplus gas will gurgle through the inlet duct, thus preventing the apparatus from exploding. Should the pressure drop excessively, the valves 39′ will insufflate new nitrogen so as to keep the parameter within the safety values that will make the environment fully inert.

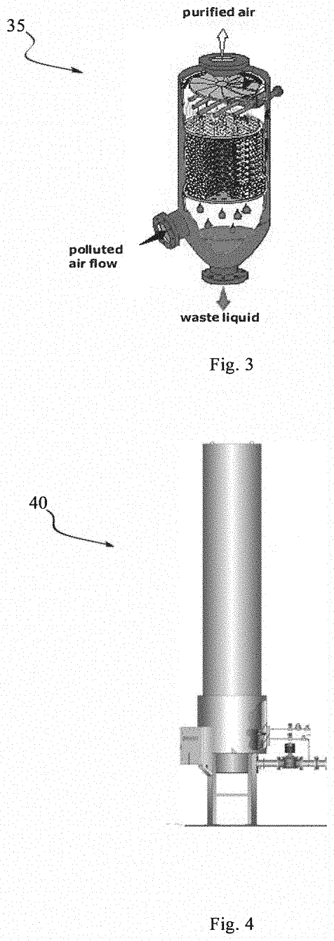

Advantageously positioned above the submersion area is a purifier 35 better illustrated in FIG. 3 which is suitable to treat the gases emitted by the crushing process impacting them with a flow of alkaline water with sodium hydroxide (whose pH is higher than 10) against the current. Said purifier 35 will allow to absorb the inorganic gases and acids and possible solvents, thus reducing the risk of emissions.

All the produced hydrogen is sent to the burning carried out by a torch 40 like the one represented in FIG. 4 or, if the degree of purity is sufficiently high, to energy recovery in a fuel cell, arranged outside the structure of the crushing area 30. In order to monitor the chemical composition of the gas flowing into the torch 40 (given the impossibility to analyse the outflowing gas) and thus in order to verify the correct operation of the purifier 35 and hence nullifying harmful emissions, positioned downstream of the torch 40 is an extractor which sends part of the transiting gas to a monitoring cabin 90. The latter is provided with an analyser consisting of at least one multi-parameter unit of the FT-IR (Fourier Transform Infra Red) type and a specific TOC (Total Organic Carbon) unit for analysing inorganic gases and acids and volatile solvents respectively.

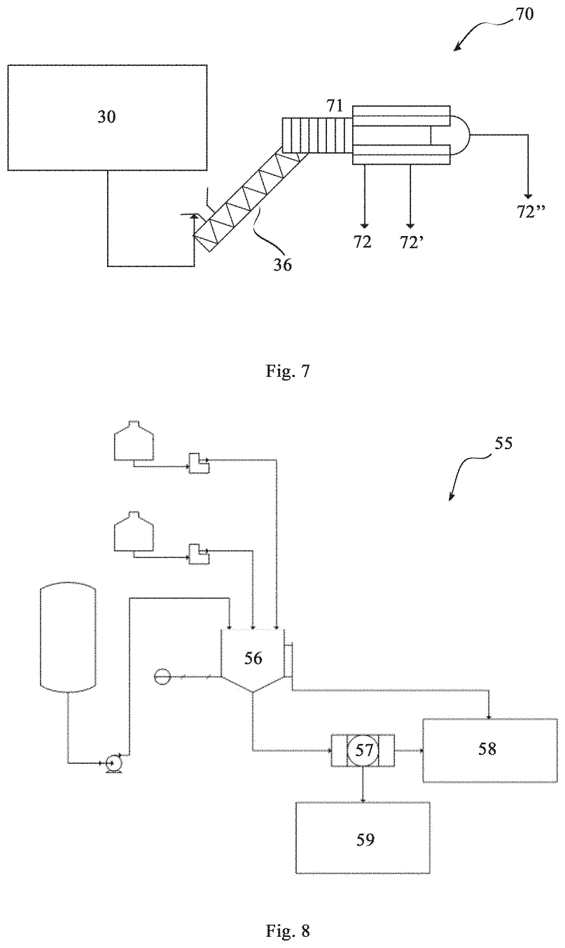

Returning downstream of the crushing area 30, the solid component of the residues falls towards a discharge auger 36 which transfers it to the scrap screening area 70 represented in FIG. 7. The scrap material coming from the grinding, commonly referred to as “black mass” is subjected to centrifugation to remove the water containing lithium and screened by a common sorting system 71 and divided according to the characteristics between a plurality of container 72-72′-72″ for the subsequent recovery operations. Components containing high value metals will selected from these fractions.

The solid component in suspension, resulting from the crushing, that does not fall into the auger 36, is instead sent to a filter 34 followed by a recycling pump 34′. From here, part of the solid components is re-introduced into the crushing area 30 so as to be subjected to a new mincing and another part is conveyed towards a filter for eliminating solids 45 which sorts the received material between an evaporation area 50 and a heavy metals recovery area 55.

The heavy metals recovery area 55 (FIG. 8) collects the process water flowing out from the crushing 30 which must be filtered to remove the solid particles with size greater than a pre-established threshold, for example 100 □m. A chemical/physical reactor provided with a stirrer 56, by means of a filter press 57, sorts the obtained products between a liquid waste tank 58 and a solids tank 59 containing the heavy metals to be disposed. Some precious metal to be sent to recovery could be present between the solid material, while the filtered water is stored and subsequently sent to the evaporation area 50.

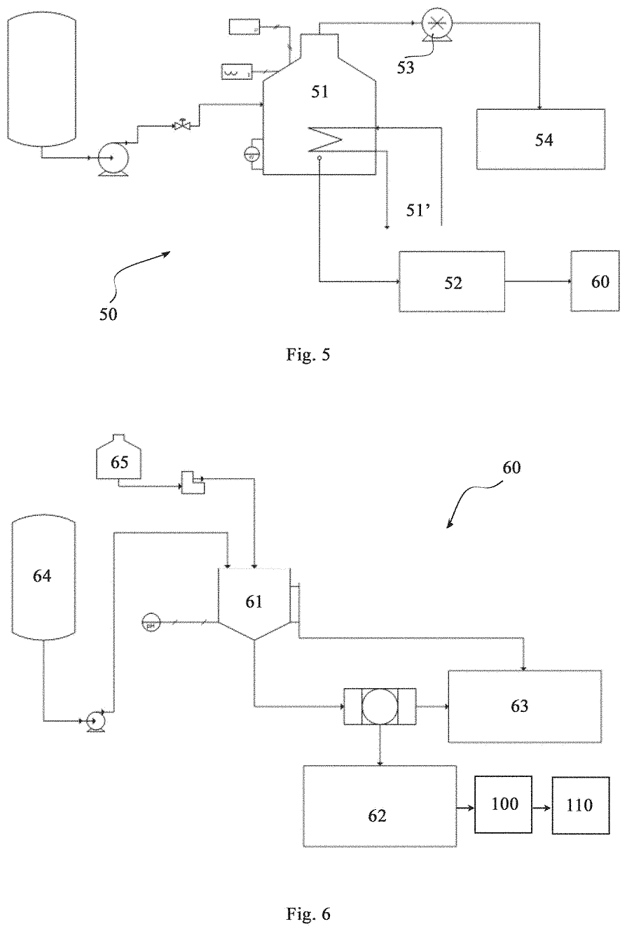

The evaporation area 50 collects water containing organic solvents and diluted Lithium in solution. It is suitable to carry out a semi-discontinuous under vacuum evaporation to remove the volatile solvents and concentrate the Lithium in solution. The operating diagram thereof is represented in FIG. 5 which shows an evaporator 51 provided with a vapour recirculation system 51′ connected to a boiler (not represented). The evaporator 51 needs steam for supplying evaporation energy to the system, hence the plant must be provided with an appropriate generator. The product flowing into the evaporation area 50 is substantially sorted half between “evaporated” and “concentrated” conveying the outflowing product, alternatively into a concentrated product tank 52, in turn connected to a treatment and recovery area 60, and an evaporated product tank 54, by means of a common vacuum pump 53.

The Lithium recovery area 60 (FIG. 6) is the one in which the precipitation reaction occurs:

2 L(OH)+NaCO₃+heat→Li₂CO₃₍ₛ₎+2 Na(OH)

Following concentration, the evaporation process waste liquid (evaporation area 50) contained in a heated tank 64, is transferred to heated chemical/physical reactor and with stirrer 61 where the aforementioned reaction occurs by adding concentrated sodium carbonate (Na₂CO₃) coming from a special tank 65 and at a temperature higher than 60° C.

The waste products of the Lithium recovery area 60 are sorted between a liquids tank 63 and a Lithium dryer 62 in turn connected to the analysis laboratory 100 and to the relative weighing and packaging installation 110 for re-introduction of Lithium into the market according to pre-established purity parameters (BP or USP).

Said analysis laboratory 100 has all the analysis equipment required for analysing the process and finished product. Present is also an area for preparing the sample and storing the reagents as well as at least one data analysis and storage station.

All areas for the storage of solid waste coming from the aforementioned processing are suitably configured to avoid any possible spilling of the content and they are positioned in sheltered areas.

The storage of treatment intermediate water instead provides for providing special tanks, preferably made of concrete, provided with level sensors and booster pumps;

Lastly, the packaged products, exiting from said analysis laboratory 100 and meant to be sold will be collected in a Lithium Carbonate storage area.

Lastly, it is clear that the invention described up to now may be subjected to modifications, additions or variants obvious to a man skilled in the art, without departing from the scope of protection outlined by the attached claims.

1. Plant for the disposal of lithium batteries and recovery of lithium, comprising at least the following technical areas:
storage area (10), arranged upstream of the entire plant, protected against atmospheric agents and waterproofed, in which lithium batteries and accumulators to be disposed are discharged;
supply plant (20), provided with a forklift suitable to discharge the accumulated batteries into a loading hopper from which they are conveyed to a
crushing area (30) provided with a crusher submerged in a liquid solution or in an inert atmosphere coming from a special tank (38) and submerged in the crusher by means of a common dosing pump (38′); said crusher being suitable to mechanically destroy the submerged batteries by means of cutting discs (32) and milling cutters connected to an equal number of drive shafts (31); said crusher also being provided with at least one grid (33) with mesh comprised between 10 mm and 35 mm suitable to enable the control of the grain size of the solid residues; said crushing area (30) being suitable to operate in overpressure with respect to the external environment and in an inert atmosphere due to the presence of a hydrostatic head and pressure sensors, connected to insufflation valves (39′) connected to at least one tank (39) for inert gas, so as to keep the pressure value within pre-established threshold values; said crushing area (30) being also provided, above said crusher, with at least one purifier (35) suitable to treat the gases emitted by the crushing process impacting them with a flow of water alkalized with sodium hydroxide in counter-current, so as to absorb the gases and the inorganic acids and the possible solvent vapours, reducing the risk of emissions into the atmosphere and conveying the remaining gases flowing out from said purifier (35) to a
combustion device (40), positioned outside the structure of the crushing area (30) suitable to burn the combustible gaseous residue of the crushing;
a scrap screening area (70), positioned downstream of a discharge auger or a touch chain (36) which collects the scrap deriving from the crushing, provided with a common centrifuge for eliminating process water and a common distribution system (71) suitable to distribute said scrap, based on their characteristics, among a plurality of containers (72-72′-72″) for the subsequent recovery operations; another part of the solid component, resulting from the crushing, instead being conveyed in a filter (34) followed by a recycling pump (34′) suitable to push the residues towards a filter for eliminating solids (45) in turn suitable to distribute the received material between an evaporation area (50) and an area for recovering heavy metals (55);
said evaporation area (50), suitable to collect the water containing organic solvents and lithium diluted in solution and perform a semi-discontinuous vacuum evaporation to remove the volatile solvents and concentrate the lithium in solution; said evaporation area (50) being provided with at least one evaporator (51) with a system for recirculating the vapour (51′) connected to at least one tank of the concentrated product (52), in turn connected to a lithium treatment and recovery area (60) and a tank for the evaporated product (54), by means of a common vacuum pump (53);
said heavy metals recovery area (55), suitable to collect the process water flowing out from the crushing area (30) for removing the solid particles that are larger than a pre-established threshold; said heavy metals recovery area (55) being provided with at least one chemical/physical reactor with stirrer (56) which, through a filter press (57), is suitable to distribute the obtained products between a liquid waste tank (58) and a solids tank (59) containing the heavy metals to be disposed;
said lithium recovery area (60) in which lithium was recovered by crystallising lithium carbonate by adding sodium carbonate, contained inside a tank (65) and heating the solution coming from said evaporation area (50) in a special tank (64) heated up to a temperature of about 60° C., according to the following precipitation reaction:
2 (OH)+NaCO₃+heat→Li₂CO₃₍ₛ₎+2 Na(OH)
said reaction occurring in a chemical/physical reactor with stirrer (61); the waste products exiting from said lithium recovery area (60) being distributed between a liquids tank (63) and a lithium dryer (62).

2. The plant for the disposal of Lithium batteries and recovery of lithium, according to claim 1, wherein the plant enables the recovery of lithium at a degree of purity according to at least one of the following technical standards, pharmaceutical standards or similar standards:
BP (British Pharmaceutical) whose specifications are as follows:
Li₂CO₃—73.9—554-13-2;
content: 98.5% to 100.5%;
appearance: white or almost white powder;
solubility: slightly soluble in water, practically insoluble in 96% ethanol;
USP (United States Pharmaceutical), whose specifications are as follows:
Li₂CO₃—73.89;
carbonic acid, dilithium salt;
dilithium carbonate—[554-13-2] containing not less than 99.0% of Li₂CO₃, calculated on the dried base.

3. The plant for the disposal of Lithium batteries and recovery of lithium, according to claim 1, further comprising at least one analysis laboratory (100) provided with all analytical equipment and suitable for analysing the process and the degree of purity of the recovered lithium; said analysis laboratory (100) being suitable to verify whether the recovered lithium meets the parameters that enable the selling thereof, possibly in the pharmaceutical industry too; said analysis laboratory (100) also being provided with an area for preparing the sample and storing the reagents and with at least one station for analysing and storing the process data.

4. The plant for the disposal of Lithium batteries and recovery of lithium, according to claim 3, wherein downstream of said analysis laboratory (100) a common weighing and packaging installation (110) suitable to package a predetermined amount of lithium carbonate suitable to be sold and intended to be placed in the market is provided.

5. The plant for the disposal of Lithium batteries and recovery of lithium, according to claim 3, further comprising a plurality of waste storage areas, all positioned in sheltered areas, away from atmospheric agents, including at least:
a solid waste storage area suitably configured to avoid any possibility of the content spilling;
a treatment intermediate process water storage area, provided with special tank provided with level sensors and booster pumps;
a lithium carbonate storage area suitable to collect the packaged products, exiting from said analysis laboratory 100 and meant to be sold.

6. The plant for the disposal of Lithium batteries and recovery of lithium, according to claim 1, further comprising a monitoring cabin (90) arranged upstream of said torch (40) provided with an extractor suitable to divert the flow of at least one part of the gases directed towards said torch (40) to enable the analysis of the composition of said gases; said monitoring cabin (90) being provided with at least one analyser consisting of at least one multi-parameter unit of the FT-IR (Fourier Transform Infra Red) type and a specific unit for the TOC (Total Organic Carbon) suitable to respectively analyse gases and inorganic acids and volatile solvents possibly present in said gas directed towards said torch (40).

7. The plant for the disposal of Lithium batteries and recovery of lithium, according to claim 1, wherein said storage area (10) is divided into at least two compartments into which the waste is alternatively discharged for storage according to the “First In-First Out” criterion.

8. The plant for the disposal of Lithium batteries and recovery of lithium, according to claim 1, wherein said storage area (10) and said crushing area (20) are separated by a fire and explosion-proof partitioning system which is traversed by the supply line (20) only.

9. The plant for the disposal of Lithium batteries and recovery of lithium, according to claim 1, wherein said crushing area (30) is provided with a foam discharge system (37) and an alternating current asynchronous electric motor, suitable to drive said drive shafts (31), arranged outside the submerged portion of said crushing area (30).

10. The plant for the disposal of Lithium batteries and recovery of lithium, according to claim 1, wherein the plant is suitable for destroying and disposing, with recovery of lithium, all types of lithium batteries and accumulators, irrespective of the operating technology.

11. The plant for the disposal of Lithium batteries and recovery of lithium, according to claim 1, wherein said combustion device (40) is a torch or a fuel cell for producing electric power starting from hydrogen coming from the crushing process and atmospheric oxygen or synthesis process.

12. The plant for the disposal of lithium batteries and recovery of lithium of claim 1, wherein
the at least one tank for inert gas contains nitrogen; and
the pre-established threshold values for pressure value are 20 mBars and 120 mBars.

13. The plant for the disposal of Lithium batteries and recovery of lithium, according to claim 2, characterised in that it comprises at least one analysis laboratory (100) provided with all analytical equipment and suitable for analysing the process and the degree of purity of the recovered lithium; said analysis laboratory (100) being suitable to verify whether the recovered lithium meets the parameters that enable the selling thereof, possibly in the pharmaceutical industry too; said analysis laboratory (100) also being provided with an area for preparing the sample and storing the reagents and with at least one station for analysing and storing the process data.

14. The plant for the disposal of Lithium batteries and recovery of lithium, according to claim 5, wherein the special tanks are made of concrete.

15. The plant for the disposal of Lithium batteries and recovery of lithium, according to claim 4, further comprising a plurality of waste storage areas, all positioned in sheltered areas, away from atmospheric agents, including at least:
a solid waste storage area suitably configured to avoid any possibility of the content spilling;
a treatment intermediate process water storage area, provided with special tanks provided with level sensors and booster pumps;
a lithium carbonate storage area suitable to collect the packaged products, exiting from said analysis laboratory 100 and meant to be sold.

16. The plant for the disposal of Lithium batteries and recovery of lithium, according to claim 2, further comprising a monitoring cabin (90) arranged upstream of said torch (40) provided with an extractor suitable to divert the flow of at least one part of the gases directed towards said torch (40) to enable the analysis of the composition of said gases; said monitoring cabin (90) being provided with at least one analyser consisting of at least one multi-parameter unit of the FT-IR (Fourier Transform Infra Red) type and a specific unit for the TOC (Total Organic Carbon) suitable to respectively analyse gases and inorganic acids and volatile solvents possibly present in said gas directed towards said torch (40).

17. The plant for the disposal of Lithium batteries and recovery of lithium, according to claim 3, further comprising a monitoring cabin (90) arranged upstream of said torch (40) provided with an extractor suitable to divert the flow of at least one part of the gases directed towards said torch (40) to enable the analysis of the composition of said gases; said monitoring cabin (90) being provided with at least one analyser consisting of at least one multi-parameter unit of the FT-IR (Fourier Transform Infra Red) type and a specific unit for the TOC (Total Organic Carbon) suitable to respectively analyse gases and inorganic acids and volatile solvents possibly present in said gas directed towards said torch (40).

18. The plant for the disposal of Lithium batteries and recovery of lithium, according to claim 4, further comprising a monitoring cabin (90) arranged upstream of said torch (40) provided with an extractor suitable to divert the flow of at least one part of the gases directed towards said torch (40) to enable the analysis of the composition of said gases; said monitoring cabin (90) being provided with at least one analyser consisting of at least one multi-parameter unit of the FT-IR (Fourier Transform Infra Red) type and a specific unit for the TOC (Total Organic Carbon) suitable to respectively analyse gases and inorganic acids and volatile solvents possibly present in said gas directed towards said torch (40).

19. The plant for the disposal of Lithium batteries and recovery of lithium, according to claim 5, further comprising a monitoring cabin (90) arranged upstream of said torch (40) provided with an extractor suitable to divert the flow of at least one part of the gases directed towards said torch (40) to enable the analysis of the composition of said gases; said monitoring cabin (90) being provided with at least one analyser consisting of at least one multi-parameter unit of the FT-IR (Fourier Transform Infra Red) type and a specific unit for the TOC (Total Organic Carbon) suitable to respectively analyse gases and inorganic acids and volatile solvents possibly present in said gas directed towards said torch (40).

20. The plant for the disposal of Lithium batteries and recovery of lithium, according to claim 2, wherein said storage area (10) is divided into at least two compartments into which the waste is alternatively discharged for storage according to the “First In-First Out” criterion.
